(19) United States
(12) Patent Application Publication
(10) Pub. No.: US 2004/0050915 A1
(43) Pub. Date: Mar. 18, 2004

(54) System and method for mounting electronic components onto flexible substrates

(76) Inventors: Lakhi Nandlal Goenka, Ann Arbor, MI (US); Lawrence Lernel Bullock, Detroit, MI (US); Jason Bullock, Detroit, MI (US); Shona Bullock, Detroit, MI (US); Peter Joseph Sinkunas, Canton, MI (US); Charles Frederick Schweitzer, Northville, MI (US); Mark D. Miller, Monroe, MI (US); Raymond Eric Foster, Detroit, MI (US); Stephen Edward Fuks, Ann Arbor, MI (US); Thomas B. Krautheim, Belleville, MI (US)

Correspondence Address: BRINKS HOFER GILSON & LIONE, P.O. BOX 10395, CHICAGO, IL, 60611, US

(21) Appl. No.: 10/148,932

(22) PCT Filed: Oct. 3, 2001
(86) PCT No.: PCT/US01/31150

(51) Int. Cl. B23K 31/02

(52) U.S. Cl. 228/248.1; 228/233.2; 228/43

(57) ABSTRACT

A system and method for reflowing solder to interconnect a plurality of electronic components (24) to a substrate (12) is disclosed. The system includes an oven for preheating the substrate (12) and the plurality of electronic components (24) disposed thereon, a supplemental heat source disposed in the oven for providing additional heat energy to reflow the solder (72), a pallet (14) for supporting the substrate (12), wherein the pallet (14) has at least one internal cavity (40), and a phase-transition material (42) disposed within the cavity (40) for absorbing heat from the pallet (14).

### TECHNICAL FIELD

The present invention relates to an apparatus and method for reflowing solder to electrically connect electronic components to a flexible substrate having a low softening temperature.

### BACKGROUND OF THE INVENTION

It is well known in the art to mount electronic components to rigid and flexible printed circuit boards. Typically, solder paste is applied to conductor pad regions on the rigid or flexible substrate. Components are then placed with their terminals contacting the solder paste in the pad regions. The substrate is then exposed to relatively high temperatures to activate the solder paste which melts and then solidifies to bond and electrically connect the components onto the substrate. The flexible substrates are typically made from polyimide, which exhibits good stability when exposed to high temperatures. Many film materials, including polyesters, have not been used satisfactorily for surface mount components primarily because they exhibit inadequate heat resistance and dimensional stability when exposed to the temperatures required for solder reflow.

A technique for mounting components onto flexible polyester substrates with low softening temperatures is taught by Annable in U.S. Pat. No. 5,898,992. The flexible substrate is fixed to a carrier support member. A cover is placed over the substrate. The cover has openings corresponding to component locations and with the carrier forms a carrier assembly. Solder paste is applied to the conductor regions of the substrate having component pads. Electronic components are then placed on the substrate with their terminals in contact with the solder paste. The carrier assembly is then pre-heated in a reflow oven to a temperature below the melting point of the solder paste. The assembly is then subjected to a rapid rise in temperature utilizing a supplemental heat source such as a heated gas jet. The cover shields the substrate from the high reflow temperatures and minimizes distortion of the flexible substrate during reflow.

While the prior art teaching achieve their intended purpose significant improvements are needed. For example, it would be desirable to eliminate the need for a special cover for shielding specific areas of the substrate from the heat generated by the gas jet.

### BRIEF SUMMARY OF THE INVENTION

The present invention includes a reflow pallet for the soldering of electronic components onto a flexible substrate utilizing specialized cooling arrangements to cool the substrate during the reflow process. These cooling arrangements utilize a phase change material disposed within internal cavities in the pallet. This phase change material absorbs heat from the substrate during a phase transition, thereby maintaining a lowered substrate temperature during reflow. This prevents softening of the substrate during reflow, thereby preserving its dimensional stability. Another technique to cool the pallet includes an actuated array of thermoelectric coolers located within the pallet. These thermoelectric coolers are actuated as necessary during the reflow process to cool the substrate and preserve its dimensional stability. Yet another method utilizes passages in the pallet through which water, air, or other suitable fluid is directed to absorb heat from the pallet and keep the substrate cool during the solder reflow process. These techniques allow the solder reflow of components onto flexible polyester substrates without the use of a cover on the pallet to shield the substrate during the reflow process.

The pallet and cover may be made of a suitable conductive material with good thermal diffusivity, such as a heat resistant carbon fiber composite. Other materials for the pallet include a thin layer of copper backed with a glass-filled epoxy such as FR4.

Preferably, the circuit conductors on the substrate are copper. Selected regions of the conductors referred to as component pads are provided with a surface finish such as tin or immersion silver to enhance the ease of soldering to the pads. The spaces between the conductor regions of the substrate may be filled with electrically isolated regions of copper having the same thickness as the conductor regions. These copper areas further shield the substrate during reflow by selectively absorbing heat during the reflow process.

Components may be mounted on both the top and bottom sides of the substrate. For such a substrate, the reflow process is repeated for the second side. The pallet has appropriate cavities to accommodate the components on the first side of the substrate.

The flexible circuit may comprise more than two layers of circuit conductors, commonly referred to as multi-layer circuits. For these circuits, two or more layers of the substrate film are used and bonded together with a suitable adhesive to form four or more conductor layers.

Any convenient solder paste formulation may be used provided that it can be activated at a suitable temperature. One suitable solder paste has a melting temperature of 183 degrees centigrade with a composition of 63 percent tin and 37 percent lead. Other solder paste compositions include lead-free solders that are alloys of tin, silver and copper, but exhibit higher melting temperatures of about 220 degrees centigrade.

The supplemental heat source used to activate the solder paste may be supplied by one or more jets of hot gas which are directed toward the exposed areas of the substrate. Suitably, the jet of hot gas extends transversely over the width of the substrate as it is conveyed past it on a pallet.

### BRIEF DESCRIPTION OF THE DRAWINGS

FIG. 1 is a schematic representation of an apparatus for reflowing solder to electrically connect electronic components to a flexible substrate mounted on a phase-transition pallet, in accordance with the present invention;

FIGS. 2a-2b is a cross-sectional and plan view of a preferred embodiment of the phase-transition pallet, in accordance with the present invention;

FIGS. 3a-3d are cross-sectional views of the phase-transition pallet having a flexible substrate on which electronic components are mounted on both exposed sides of the substrate, in accordance with the present invention;

FIGS. 4a-4c are unique nozzle arrangements, in accordance with the present invention;

FIGS. 5a-5b is a schematic representation of a system for reflowing solder to electrically connect electronic components to a flexible substrate using a stencil, in accordance with the present invention;

FIGS. 6a-6b is a schematic representation of a system for reflowing solder to electrically connect electronic components to a flexible substrate using staggered nozzles outlets and inlets, in accordance with the present invention;

FIGS. 7a-7c is a schematic representation of a system for reflowing solder to electrically connect electronic components to a flexible substrate using angled nozzles, in accordance with the present invention;

FIG. 8 is a schematic representation of a system for reflowing solder to electrically connect electronic components to a flexible substrate using a nozzle array, in accordance with the present invention;

FIGS. 9a-9b is a schematic representation of a system for reflowing solder to electrically connect electronic components to a flexible substrate using an annular nozzle array, in accordance with the present invention;

FIGS. 10a-10b is a schematic representation of a system for reflowing solder to electrically connect electronic components to a flexible substrate using a staggered annular nozzle array, in accordance with the present invention; and

FIGS. 11a-11b is a schematic representation of a system for reflowing solder to electrically connect electronic components to a flexible substrate using a nozzle gas injection portion and a nozzle suction portion, in accordance with the present invention.

### DETAILED DESCRIPTION OF THE INVENTION

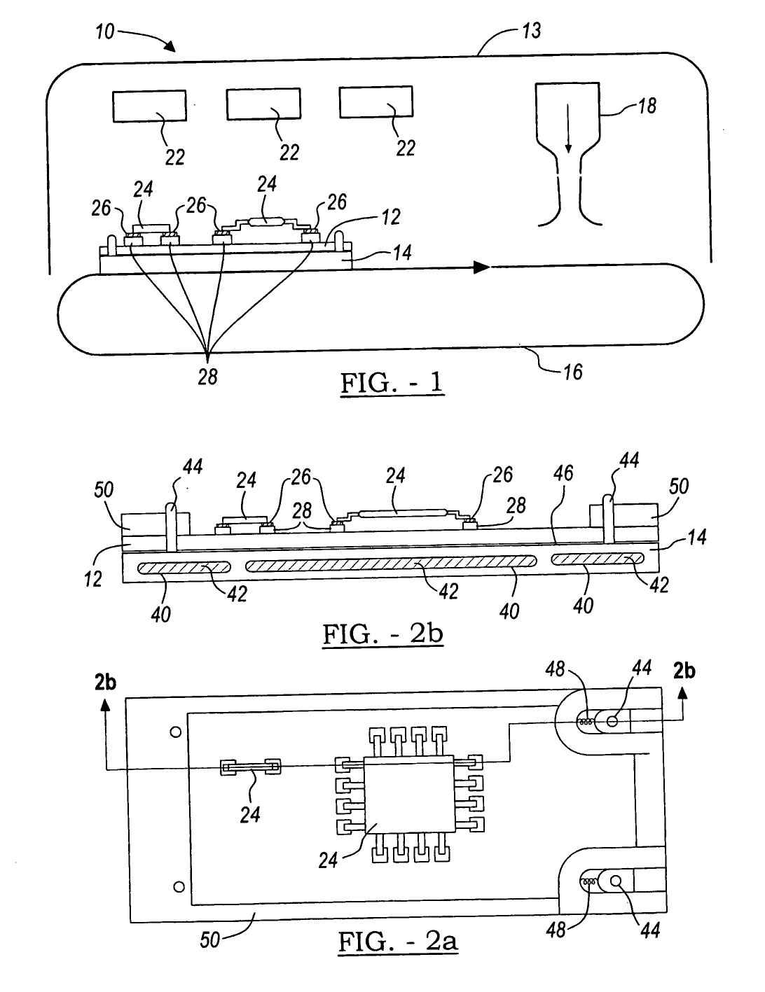

An apparatus 10 for reflowing solder to electrically interconnect electronic components to a flexible or semi-flexible substrate is illustrated in FIG. 1, in accordance with the present invention. As will become clear from the following disclosure apparatus 10 provides a means to mount circuit components on flexible substrates without a degradation in the material properties of the substrate. Apparatus 10 includes a reflow oven, a conveyor system, a supplemental heat source (gas jet) and a pallet. The reflow oven has a plurality of heaters 50 to preheat the substrate to a desired temperature. Conveyor system 30 is configured in a conventional manner to cooperatively receive pallets 51 for movement through the reflow oven.

Pallet 51 is, preferably, a phase-transition pallet for reflowing solder paste to interconnect electronic components to flexible substrates, in accordance with the present invention. Phase-transition pallet 51 is configured to support substrate 20 and cooperates with conveyor system 30 to transport substrate 20 through oven 40. Oven 40's heaters 50 pre-heat the substrate, and a heated gas jet 60 provides supplemental heat. Solder paste 70 is printed on conductor pads 80 of the substrate on which components 90 are placed.

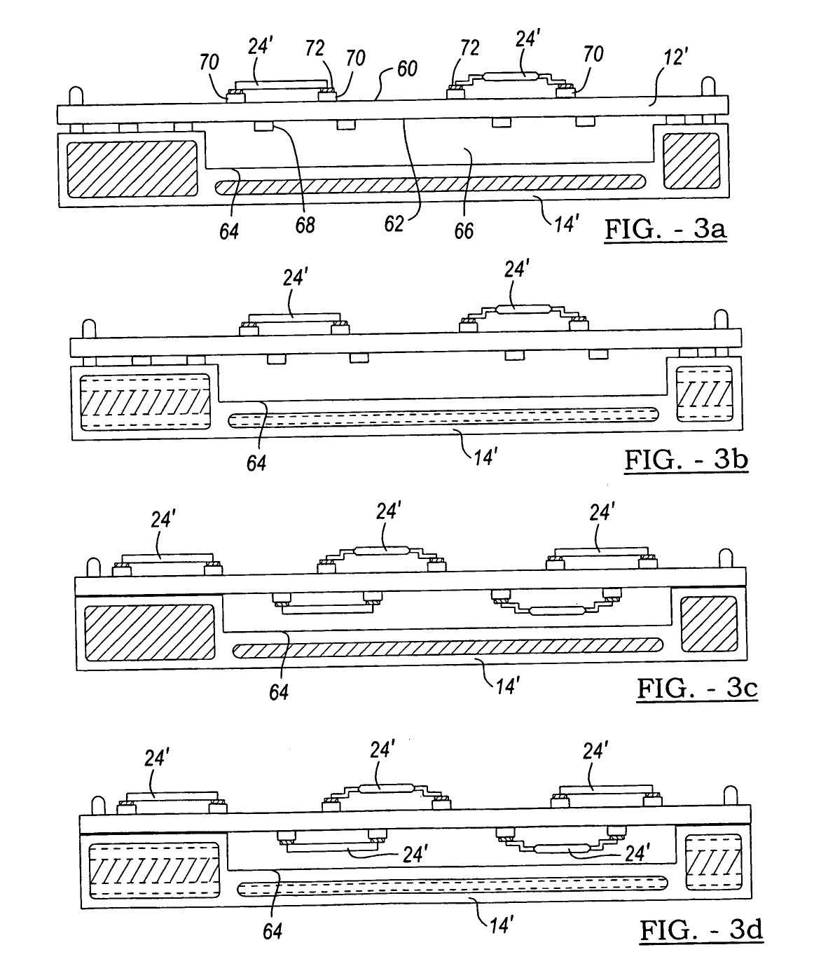

Referring now to FIGS. 2a-2b, an elevation and cross-sectional views of the phase-transition pallet 10 are illustrated, in accordance with the present invention. As shown pallet 10 includes at least one internal cavity 100 having therein a phase-change material 110. Support pins 120 are provided on pallet 10 to hold substrate 20 flat or planar on a pallet surface 125. Pins 120 may be tensioned or loaded by springs 130 to provide a tensioning force on substrate 20. In an embodiment of the present invention, a picture frame 140 may be used to secure substrate 20 against pallet surface 125. Picture frame 140, as illustrated attaches to and secures the periphery of the substrate to hold the edges of the substrate against the surface of the pallet.

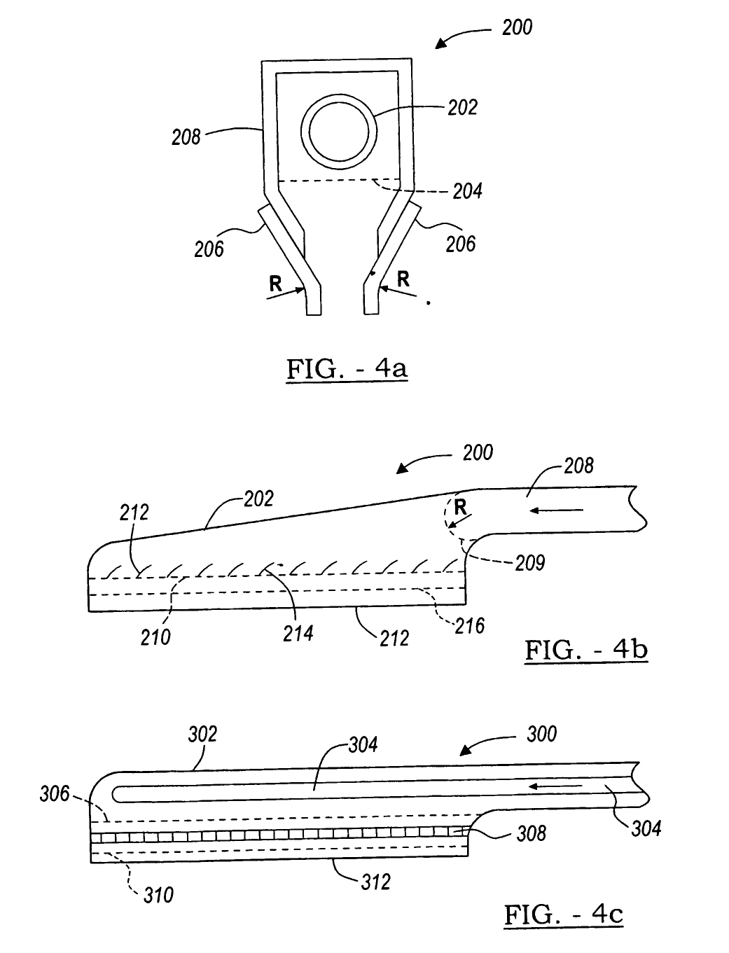

In another embodiment of the present invention, a phase-transition pallet 10 configured to accommodate a double-sided substrate on which electronic components are populated on both sides of the substrate, is illustrated. In several cross-sectional views, as depicted in FIGS. 3a-3d, pallet 10 has at least one external cavity 150 to accommodate electronic components that have been mounted on the first exposed surface of the substrate. External cavity 150 may be filled with a suitable foam 160, if necessary, to provide additional support for substrate 20.

In a preferred embodiment of the present invention, substrate 20 is a polyester film having a thickness of 0.003 to 0.010 inches. Copper conductors and solder pads may be formed on both sides of the polyester film, as is well known in the art. A suitable solder mask is applied over the copper conductors so that only the pad areas on which solder paste is to be printed are exposed. These pads may have a suitable surface finish such as an organic surface finish to protect the pad surfaces from oxide formation. Other surface finishes such as immersion silver or electroplated tin may be used to enhance the solderability of the components to the pads.

Solder pastes that have compositions containing lead, as well as solder pastes with lead-free compositions may be used. The solder pastes containing lead generally have a lower melting temperature of about 183 to 200 deg C., while lead-free solder compositions have melting temperatures of about 220 to 245 deg C.

In operation, as the pallet having the substrate affixed thereon is transported through the pre-heat zones in oven, the solder paste is activated and gradually heated to just below its melting temperature. During this process, the phase-transition material 110 begins to absorb heat from the oven as well as from the substrate 20, and thereby lowers the temperature of the substrate. The phase transition material is selected having a melting point that is lower than the melting point of the solder paste. As the phase-transition material begins to melt, the material begins to absorb an amount of heat or energy equal to the latent heat of the material. Consequently, the temperature of the phase-change material is held constant until the material is fully melted. Thus, the present invention significantly enhances the heat absorption properties of the pallet 10 and maintains a lowered substrate temperature during reflow of the solder paste.

In a preferred embodiment of the present invention, phase-transition material 110 exhibits a melting temperature lower than that of the solder, and may be comprised of conductive metals such as gallium, gallium alloys, or alloys of tin and lead. Other suitable phase transition materials include chloro-fluoro carbons and their compounds.

A supplemental heat source such as a heated gas jet 60 is utilized to provide a focused and concentrated heat source. This gas jet provides heat to the exposed substrate surface for a short duration. The solder paste, conductor pads, and copper regions of the substrate preferable absorb heat because of their high thermal diffusivity, while the substrate 20 is maintained at a lower temperature by the pallet 10, which is held at a lower temperature by the phase-transition material 110. In this manner, softening and damage to the substrate during the reflow process is prevented.

After the exposed region of the substrate passes below the gas jet 60, the temperature of the exposed electronic component and substrate rapidly falls so that the activated solder cools and solidifies. A good electrical connection between the conductors and component pads is thus formed. During this process, the phasetransition material also solidifies, so that the pallet is ready for reuse.

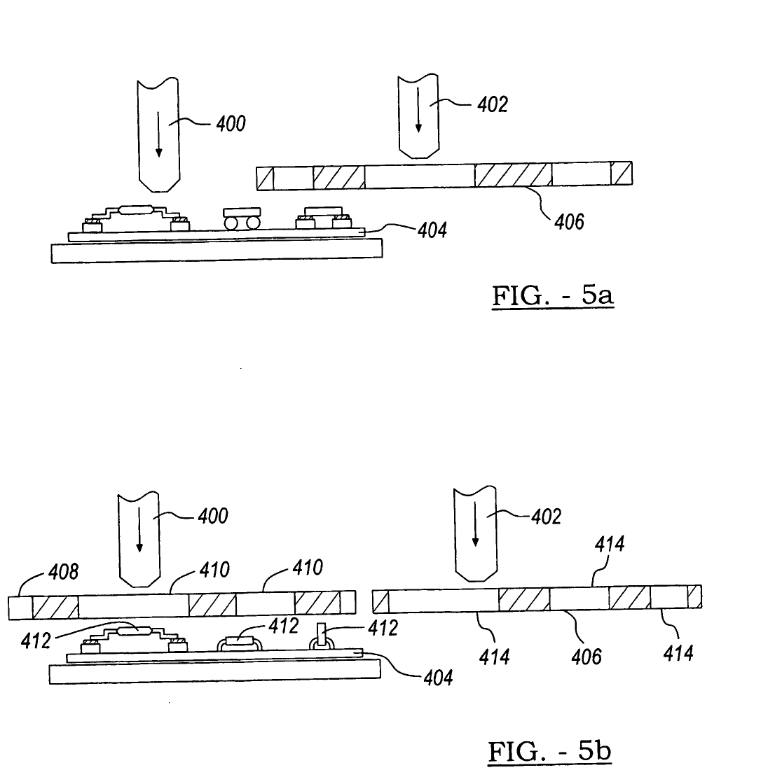

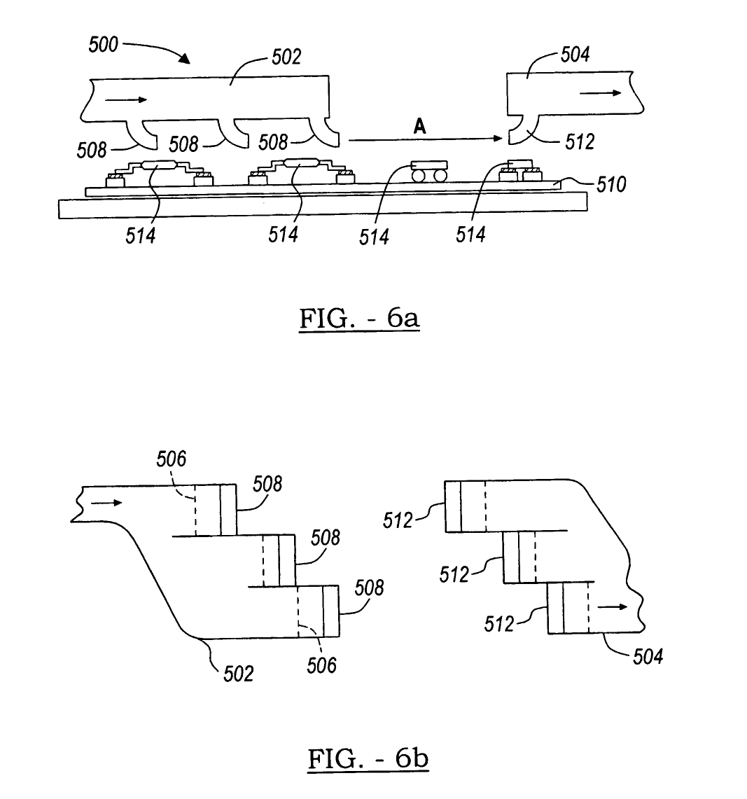

In another embodiment of the present invention, a unique nozzle 200 design for distributing hot gas over a populated flexible substrate is illustrated in FIGS. 4a-4c. The present invention provides flow and temperature uniformity across the width of the nozzle. The nozzle 200 spans the width of the reflow oven 13. As will be shown and described, the nozzle 200 utilizes distributed holes/slot areas, screen and spaced distribution of the flow feed tube 202. A combination of honeycomb screens, perforated plates and screens 204 condition the flow leaving the nozzle 200. A plain of slidable plates 206, affixed to nozzle housing 208 makes the nozzle exit 210 width adjustable for greater flexibility, sizing the area of the inlet feed 202 to that of the nozzle exit 210.

Nozzle 200 includes a nozzle housing 202 for distributing hot gas onto a flexible substrate. Hot gas is transported to the nozzle housing 202 via a hot gas distribution pipe 208 to create a uniform flow distribution. A perforated plate 210 is positioned before the exit 212 of nozzle housing 202. Perforated plate 210 may have a uniform or variable geometry associated with the perforations to insure uniform gas distribution over the width of the nozzle and substrate. Further, nozzle 200 may include adjustable side plates which are slideably secured to the nozzle housing 202. Adjustable side plates may be adjusted to reduce the size of exit 212.

Nozzle 200 includes a nozzle inlet 208, and a nozzle outlet 212. At nozzle inlet 208, hot gas is received and forced through an inlet screen 209. Inlet screen 209 is preferably a perforated plate having a radius specified by R to create a uniform gas distribution over the nozzle width. Nozzle housing 202 further includes a plurality of turning veins 214 which direct hot gas toward the nozzle exit 212. Adjacent the nozzle exit 212, is disposed a perforated plate 210 and a screen 216. Perforated plate 210 and screen 216 configured in the form of a honeycomb, provide a uniform flow out of exit 212 and across the width of nozzle 602. A pair of adjustable plates 206 are affixed to housing 202 and operate as in the previous embodiment to reduce the size of exit 212.

In another embodiment of the present invention, a unique nozzle design 300 is illustrated in FIG. 4c. Nozzle 300 includes a nozzle housing 302 having a tapered slot 304 or variable holes for receiving hot gas at an inlet 304. Hot gas is distributed over a perforated plate 306, a honeycomb filter structure 308 and a screen 310. This configuration provides a uniform gas flow through an exit 312 of housing 302.

In another embodiment of the present invention, as shown in FIGS. 5a and 5b, a combination of hot and cold gas nozzles 400, 402 are utilized to distribute hot gases over a flexible substrate 404. As will be illustrated and described the cold gas nozzle 402 is located down stream of hot nozzle 400 and is used to quickly quench the heat generated by hot nozzle 400 following solder reflow. The cooling effect created by the cold nozzle 402 prevents the heat from diffusing further into the substrate 404. Thus, the heat is confined to a surface layer of the substrate 404. In a preferred embodiment of the present invention, the hot gas nozzle 400 directs hot gases through a stencil 408 having openings 410 corresponding to component 412 locations. This reduces damage caused by excessive heating of non-populated regions of the substrate 404. The cold gas nozzle 402 directs the cold gas through a “negative stencil” 406 having openings 414 corresponding to non-populated regions of substrate 404.

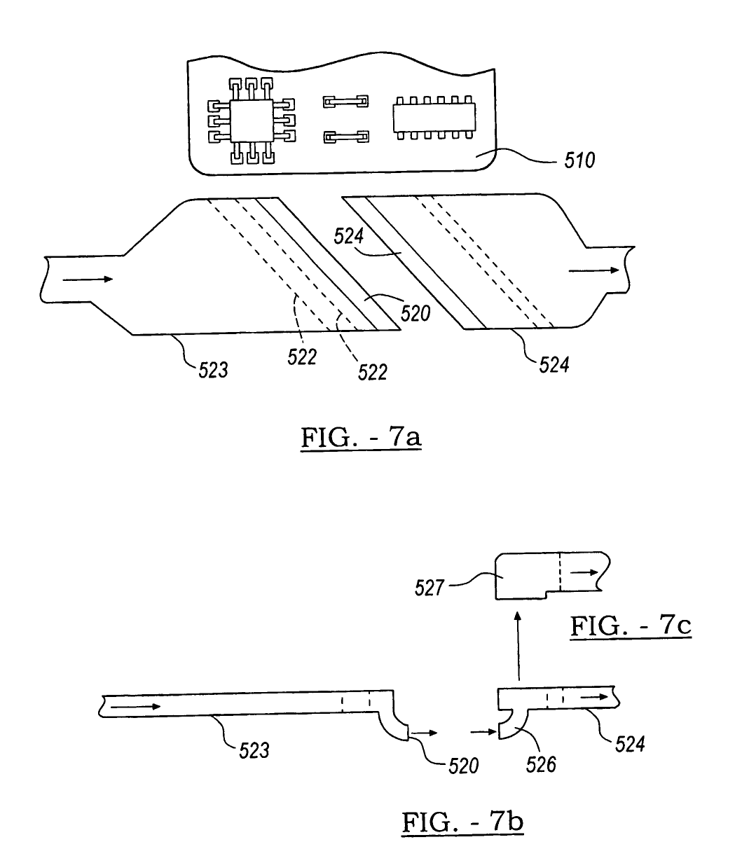

As illustrated in FIGS. 6a-6b in another embodiment of the present invention, a hot gas nozzle for distributing hot gas over a flexible substrate is illustrated. Nozzle 500 includes a hot gas distribution portion 502 and a hot gas suction portion 504. Hot gas distribution portion 502 includes a plurality of baffle plates 506 positioned before a plurality of exit ducts 508. Baffle plates 506 uniformly distribute the hot gas over the exits ducts 508, suction portion 504 of nozzle 500 is in communication with a vacuum for drawing in hot gases flowing over the flexible substrate 510. A plurality of suction inlets 512 correspond with exit ducts 508 to create a hot air stream as indicated by arrow A, which flows over electronic components 514 on the flexible substrate 510. Thus, the present invention provides narrow strips of hot gas over substrate 510 as the substrate passes under nozzle 500.

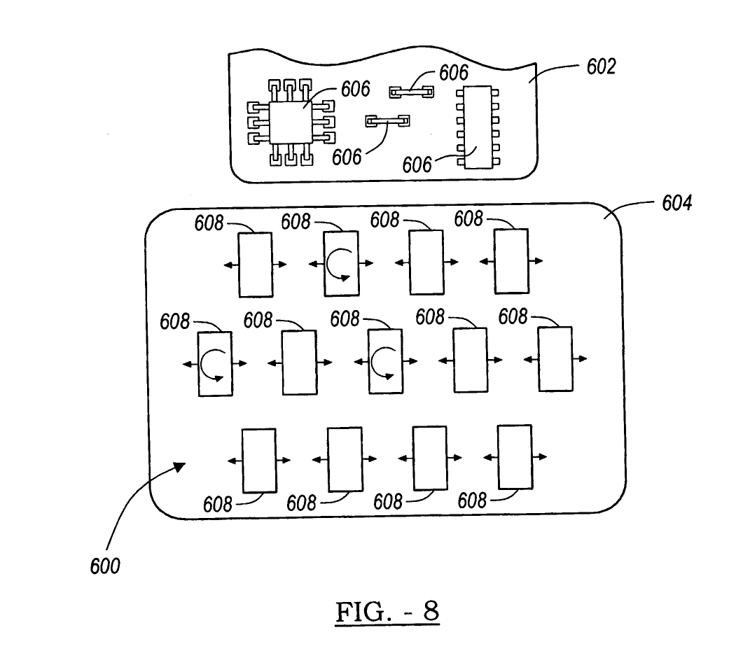

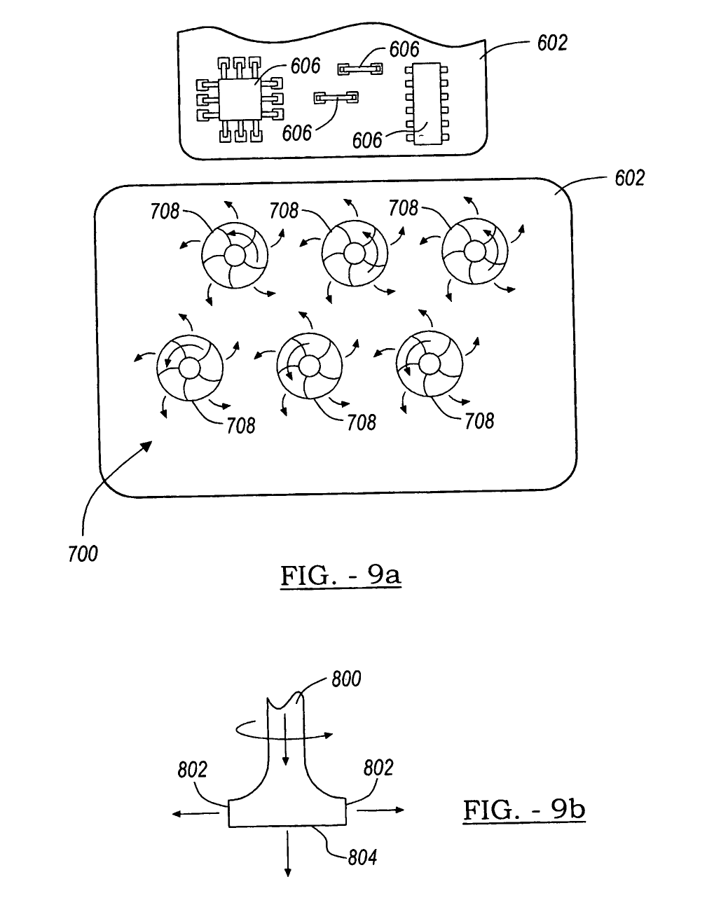

In an alternative embodiment of nozzle 500, as illustrated in FIGS. 7a-7c, hot gas portion of nozzle 502 spans the entire width of the substrate and includes a single hot gas exit 520. A plurality of diffuser plates 522 are positioned adjacent exit 520 to create a uniform hot gas distribution across substrate 510. A hot gas suction portion 524 is located down stream of hot gas injection portion 523 and similarly spans the width of the substrate 510. A vacuum is created in the suction portion 524 and cooperates with hot gas injection portion 520 to create a uniform gas stream from exit 520 to suction inlet 526 across the substrate 510. In FIG. 7c, there is illustrated an alternative suction inlet 527.

In another embodiment of the present invention as illustrated in FIG. 8, a staggered array of rotating nozzles 600 disposed within a reflow oven 602 may be used to direct a stream of hot gas onto a flexible substrate 604. The staggered array of nozzles 600 provide a supplemental heat source for reflowing solder paste on substrate 604. The staggered array 600 provides a swirl of hot gas which penetrates under the electronic components 606 to solder J-leads and BGA's. The nozzles 608 may be any combination of co-rotating and counter rotating nozzles. Additionally, the present invention contemplates oscillating and/or swiveling nozzle arrays.

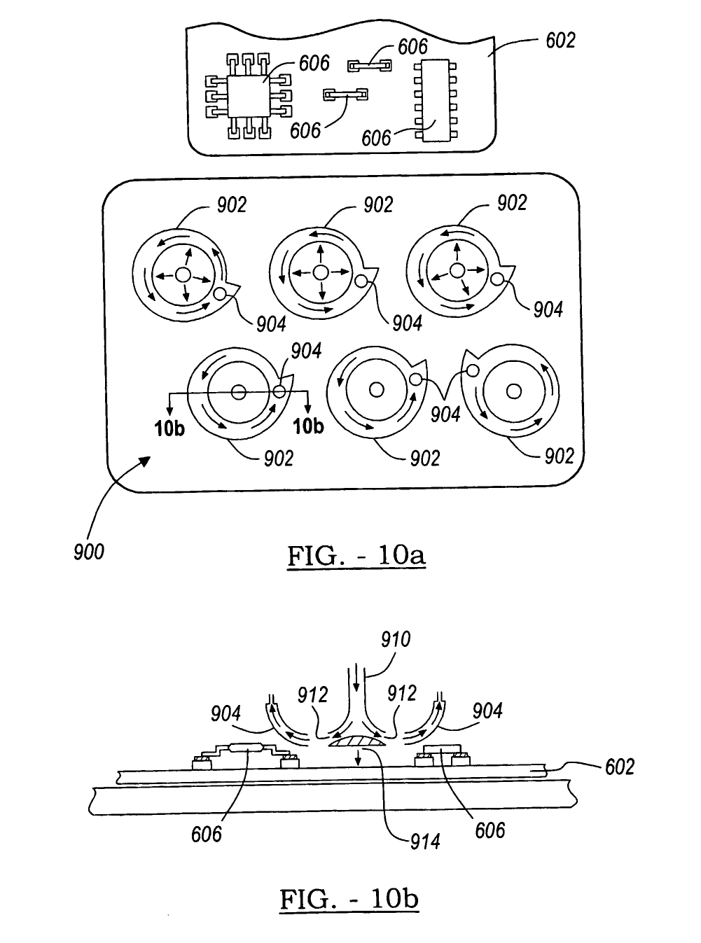

As illustrated in FIGS. 9a-9b a nozzle array 700 having a plurality of nozzles 708, wherein nozzles 708 have a rotary vein configuration are disposed above substrate 602 for distributing hot gases thereover. Nozzles 708 create a tangential swirling flow as indicated by the plurality of arrows. As indicated in FIG. 9b, hot gases are received at a nozzle inlet 800 and exit a plurality of side exits 802 and a bottom exit 804. Thus, nozzle configurations provides a swirling downwards directed gas stream.

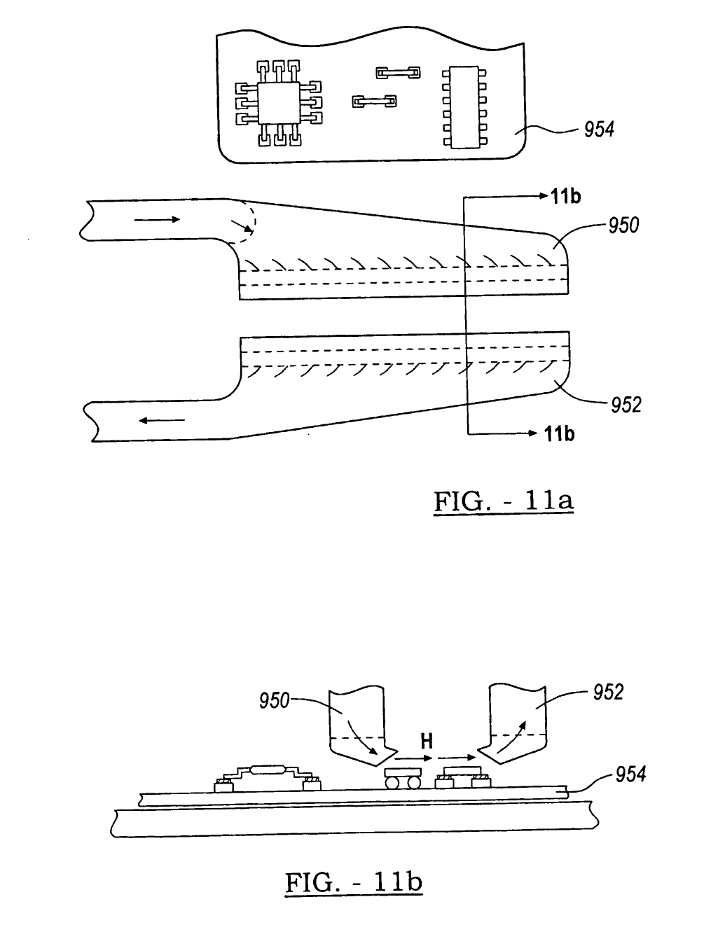

In yet another embodiment of the present invention, a staggered array 900 of annular nozzles 902 utilizing a combination of blowing and suction are used to provide a supplemental heat source to reflow the solder paste is illustrated in FIGS. 10a-10b. Such annular nozzles 902 enable components 606 to be heated from different directions, allowing heat to convect under component areas and other shadow areas of the circuit. Moreover, the staggered array of annular nozzles 902 direct heat tangentially onto the electronic components 606. As nozzle 902 injects the hot stream of gas onto substrate 602, a suction manifold 904 exhausts the hot gas away from non-populated areas. In this manner, the hot gas stream is restricted to a well defined strip along the substrate. Thus, the present embodiment controls the heating of the substrate and minimizes hot gas diffusion into the substrate. Annular nozzles 902 include a hot gas injection portion 910 in an outer hot gas suction portion 904. Hot gas is injected into hot gas portion 910 and is expelled onto the flexible substrate. Hot gas is directed radially as well as downward onto the substrate. As gas is being expelled onto the substrate, suction portion 904 acts to draw in and stop the stream of hot gas. In this manner, a controlled hot gas stream is directed onto electronic component. As indicated in FIG. 10b, hot gas is injected in an inlet 910 and then is expelled out an annular exit 912 as well as a bottom exit 914. Suction portion 904 sucks the hot gas off of the substrate thereby preventing the hot gases from passing over unpopulated portions of the flexible substrate and damaging them.

FIGS. 11a and 11b illustrate a gas inject portion 950 and a suction portion 952 for reflowing solder on a flexible substrate 954. As indicated by arrows H hot gas is injected by gas inject portion 950 and drawn across electronic components 956 to by suction portion 952. In this way solder disposed between the electronic components and the substrate is melted and damage to the substrate is avoided.

While the present invention has been particularly described in terms of the specific embodiments thereof, it will be understood that numerous variations of the invention are within the skill of the art and yet are within the teachings of the technology and the invention herein. Accordingly the present invention is to be broadly construed and limited only by scope ad spirit of the following claims.

1. A system for reflowing solder to interconnect a plurality of electronic components to a substrate, the system comprising:
an oven for preheating the substrate and the plurality of electronic components disposed thereon;
a supplemental heat source disposed in the oven for providing additional heat energy to reflow the solder;
a supplemental heat source extractor for removing heat from the susbstrate;
a pallet for supporting the substrate; and
a phase-transition material disposed within the cavity for absorbing heat from the pallet.

2. The system of claim 1 wherein a supplemental heat source extractor is a vacuum.

3. The system of claim 2 wherein a supplemental heat source extractor has a plurality of staggered vacuum inlets to draw a stream of gas over the substrate.

4. The system of claim 1 wherein the supplemental heat source is a gas nozzle for directing hot gas onto the substrate.

5. The system of claim 4 wherein the gas nozzle has adjustable side portions for changing a size of an exit of the nozzle.

6. The system of claim 4 wherein the gas nozzle has a screen to uniformly distribute hot gas over the substrate.

7. The system of claim 4 wherein the gas nozzle has a plurality of staggered outlets to distribute hot gas over the substrate.

8. The system of claim 4 wherein the gas nozzle is configured to rotate.

9. The system of claim 4 wherein the gas nozzle is configured to oscillate.

10. The system of claim 4 wherein the gas nozzle is an annular nozzle.

11. The system of claim 1 further comprising a conveyor for transporting the pallet through the oven and under the supplemental heat source.

12. The system of claim 1 further comprising a stencil positioned between the supplemental heat source and the electronic components to direct hot gas onto portions of the substrate.

13. The system of claim 1 wherein the supplemental heat source further comprises an array of hot gas nozzles, wherein the nozzles are independently actuatable and controllable to reflow the solder.

14. A method for soldering electronic components onto a substrate comprising:
a. applying solder paste to the substrate;
b. placing electronic components on the substrate to form a substrate assembly;
c. locating the substrate assembly on the reflow pallet;
d. preheating the substrate and electronic components to a first elevated temperature below a softening temperature of the deposited solder paste;
e. exposing the deposited solder paste to further rapid localized heating to a temperature sufficient to melt the solder paste using a supplemental heat source; and
f. extracting heat from the substrate to prevent damage to the substrate using a vacuum.

15. The method of claim 14 further comprising directing hot gas onto the substrate using a gas nozzle.

16. The method of claim 14 further comprising transporting the pallet through under the supplemental heat source using a conveyor.

17. The method of claim 14 further comprising extracting hot gas from the substrate using a vacuum nozzle.
